(19) United States
(12) Patent Application Publication
(10) Pub. No.: US 2024/0337563 A1
(43) Pub. Date: Oct. 10, 2024

(54) FAILURE DIAGNOSIS SYSTEM FOR MARINE ENGINE COMBUSTION CHAMBER AND METHOD FOR DIAGNOSING FAILURE OF MARINE ENGINE COMBUSTION CHAMBER USING THE SAME

(71) Applicant: KOREAN REGISTER, Busan (KR)

(72) Inventors: Hwasup JANG, Busan (KR); Jaechul PARK, Busan (KR); Gapheon LEE, Busan (KR)

(73) Assignee: KOREAN REGISTER, Busan (KR)

(21) Appl. No.: 18/619,318

(22) Filed: Mar. 28, 2024

(30) Foreign Application Priority Data
Apr. 10, 2023 (KR) 10-2023-0046754

(51) Int. Cl. G01M 15/05

(52) U.S. Cl. CPC G01M 15/05

(57) ABSTRACT

In a failure diagnosis system for a marine engine combustion chamber and a method for diagnosing failure of the marine engine combustion chamber using the failure diagnosis system, the failure diagnosis system includes a PV diagram obtaining part, a feature value extracting part, and a diagnosis analyzing part. The PV diagram obtaining part is configured to obtain a PV diagram for each of cylinders operated in a marine engine. The feature value extracting part is configured to extract pre-defined feature values from the PV diagram. The diagnosis analyzing part is configured to diagnose a normal state or an abnormal state of a cylinder combustion operation from the feature values extracted from the cylinder, using a pre-learning result which is learned for the normal state or the abnormal state of the cylinder combustion operation using the pre-defined feature values.

This application claims priority under 35 U.S.C. § 119 to Korean Patent Application No. 10-2023-0046754, filed on Apr. 10, 2023, the disclosure of which is incorporated by reference herein in its entirety.

### BACKGROUND

### 1. Field of Disclosure

The present disclosure of invention relates to a failure diagnosis system for a marine engine combustion chamber and a method for diagnosing failure of the marine engine combustion chamber using the same, and more specifically the present disclosure of invention relates to a failure diagnosis system for a marine engine combustion chamber and a method for diagnosing failure of the marine engine combustion chamber using the same, capable of determining whether the marine engine combustion chamber is in normal operating condition based on a pressure information within the combustion chamber.

### 2. Description of Related Technology

Recently, as the volume of logistics using ships increases, safety accidents on ships are also increasing. In the case of ships, the damage caused when a safety accident occurs is enormous, and therefore prevention of safety accidents on ships is the most important element in the ship management system.

Accordingly, various technologies are being developed in relation to the prevention of safety accidents on the ships. For example, Korean patent No. 10-1732625 discloses the technology on the diagnosis device for the ships, and the technology to perform failure diagnosis by analyzing the cause of failure of various devices on the ship based on statistical data is disclosed.

However, in addition to the overall operating condition of the ships, especially a marine engine combustion chamber is the most important part of the ship operation, and accordingly, diagnosing in advance whether the combustion chamber engine is running is very important in ensuring the stability of the ship operation.

Nevertheless, the technology to diagnose the engine operation status based on the internal pressure of the combustion chamber of the marine engine is still underdeveloped.

### SUMMARY

The present invention is developed to solve the above-mentioned problems of the related arts.

The present invention provides a failure diagnosis system for a marine engine combustion chamber, capable of increasing quickness and accuracy of judgment by determining whether the marine engine combustion chamber is in normal operating condition based on a pressure information within the combustion chamber.

In addition, the present invention also provides a method for diagnosing failure of the marine engine combustion chamber using the failure diagnosis system for the marine engine combustion chamber.

According to an example embodiment, the failure diagnosis system includes a PV diagram obtaining part, a feature value extracting part, and a diagnosis analyzing part. The PV diagram obtaining part is configured to obtain a PV diagram for each of cylinders operated in a marine engine. Here, the PV diagram shows a relationship between a volume of the cylinder and a pressure of the cylinder. The feature value extracting part is configured to extract pre-defined feature values from the PV diagram. The diagnosis analyzing part is configured to diagnose a normal state or an abnormal state of a cylinder combustion operation from the feature values extracted from the cylinder, using a pre-learning result which is learned for the normal state or the abnormal state of the cylinder combustion operation using the pre-defined feature values.

In an example, the diagnosis analyzing part may include a database configured to store the pre-defined feature values extracted from each of the cylinders with the normal state and the abnormal state, a learning part configured to learn the feature values of the cylinder with the normal state and the feature values of the cylinder with the abnormal state, which are stored in the database, and a deciding part configured to decide whether the cylinder combustion operation is in the normal state or in the abnormal state, from the feature values extracted from the cylinder, using learned results of the learning part.

In an example, the PV diagram may be a graph showing a change of a pressure inside of the cylinder according to a change of a position of a piston inside of the cylinder.

In an example, the pre-defined feature values may include at least one of a maximum value of pressure (Pmax), a compression or expansion stroke area (Pic), an intake and exhaust stroke area (Pis), a difference between maximum pressure and pressure during fuel injection (ΔP), an angle difference between maximum pressure and fuel injection (Δθj), a slope between maximum pressure and fuel injection (Slope), and a curvature from maximum pressure to bottom dead center (Cur).

In an example, the maximum value of pressure (Pmax) may be obtained by Equation (1) below.

$${P}_{ma x} = \frac{1}{N} {{\sum }_{i = 1}}^{N} {P}_{i} \qquad Equation ( 1 )$$

Here, N may be the number of samples within ±1° based on a fuel injection angle when the pressure has a maximum value.

In an example, the compression or expansion stroke area (Pic) may be obtained by Equation (2) below.

$${P}_{ic} = {\int }_{{TDC}_{c} - 180 °}^{{TDC}_{c} + 180 °} Pd ⊖ \qquad Equation ( 2 )$$

Here, TDCc may be a top dead center of a piston, P may be a pressure, and θ may be a crank angle.

In an example, the intake and exhaust stroke area (Pis) may be obtained by Equation (3) below.

$${P}_{is} = {\int }_{{TDC}_{s} - 180 °}^{{TDC}_{s} + 180 °} Pd ⊖ \qquad Equation ( 3 )$$

Here, TDCs may be a top dead center of a piston, P may be a pressure, and θ may be a crank angle.

In an example, slope between maximum pressure and fuel injection (Slope) may be obtained by Equation (4) below.

$$Slope = \frac{△ P}{△ {⊖}_{j}} \qquad Equation ( 4 )$$

Here, ΔP may be the difference between maximum pressure and pressure during fuel injection, and Δθj may be the angle difference between maximum pressure and fuel injection.

In an example, the feature value extracting part may be configured to extract the features values as an average value during a predetermined time.

According to another example embodiment, a method for diagnosing failure includes obtaining a PV diagram for each of cylinders operated in a marine engine, the PV diagram showing a relationship between a volume of the cylinder and a pressure of the cylinder, extracting pre-defined feature values from the PV diagram, learning the feature values of the cylinder with a normal state and the feature values of the cylinder with an abnormal state, which are stored in a database, and diagnosing the normal state or the abnormal state of the cylinder, using learning results in the learning the feature values of the cylinder.

In an example, the pre-defined feature values may include at least one of a maximum value of pressure (Pmax), a compression or expansion stroke area (Pic), an intake and exhaust stroke area (Pis), a difference between maximum pressure and pressure during fuel injection (ΔP), an angle difference between maximum pressure and fuel injection (Δθj), a slope between maximum pressure and fuel injection (Slope), and a curvature from maximum to bottom dead center (Cur).

According to the present example embodiments, feature values are extracted from the PV diagram for the cylinder combustion operation and a state of the cylinder combustion operation is diagnosed by performing the learning based on the feature values, so that the combustion conditions in the marine engine combustion chamber may be diagnosed more fast and accurate.

Here, unlike the conventional diagnosis of the cylinder combustion operation state, total 7 feature values are defined and the feature values are extracted from the PV diagram to diagnose the cylinder combustion operation state, so that the accuracy of diagnosis of the cylinder combustion operation state may be enhanced, by considering redundant consideration of various feature values.

In addition, in diagnosing the cylinder combustion operation state based on the feature values, the learning results through the learning part are utilized. Thus, unnecessary calculations on multiple feature values are minimized, and the operation state may be diagnosed by analyzing the correlation between the feature values using an artificial intelligence. Then, calculation time and judgment time may be minimized, and the accuracy of the diagnosis may also be improved.

### BRIEF DESCRIPTION OF THE DRAWINGS

FIG. 1 is a block diagram illustrating a failure diagnosis system for a marine engine combustion chamber according to an example embodiment of the present invention;

FIG. 2 is a graph showing feature values extracted from a PV diagram of FIG. 1;

FIG. 3 is a flow chart illustrating a method for diagnosing failure of the marine engine combustion chamber using the failure diagnosis system of FIG. 1;

FIG. 4 is a schematic view illustrating a failure state of cylinders of the marine engine, in the failure diagnosis test using the failure diagnosis system of FIG. 1;

FIG. 5A and FIG. 5B are graphs showing an accuracy of the diagnosis results of the learning part, in the failure diagnosis test using the failure diagnosis system of FIG. 1; and

FIG. 6A and FIG. 6B are graphs showing reliability of the learning results of the learning part, the failure diagnosis test using the failure diagnosis system of FIG. 1.

### DETAILED DESCRIPTION

The invention is described more fully hereinafter with Reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the invention is described more fully hereinafter with reference to the accompanying drawings, in which embodiments of the invention are shown.

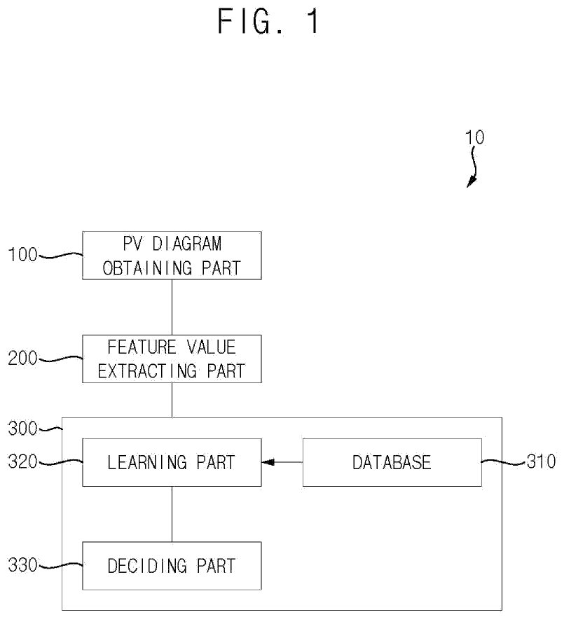

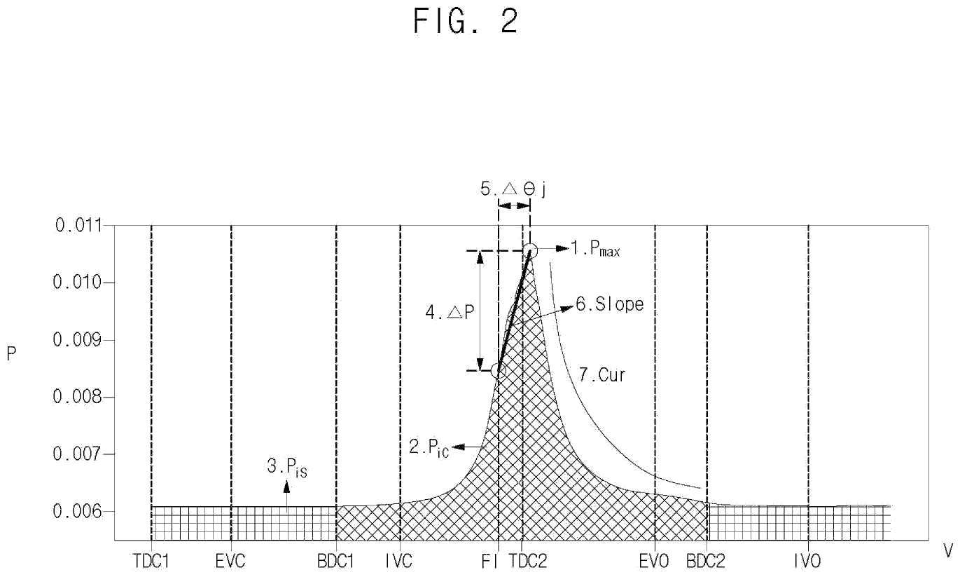

FIG. 1 is a block diagram illustrating a failure diagnosis system for a marine engine combustion chamber according to an example embodiment of the present invention. FIG. 2 is a graph showing feature values extracted from a PV diagram of FIG. 1.

Referring to FIG. 1, the failure diagnosis system for the marine engine combustion chamber 10 (hereinafter, the failure diagnosis system) includes a PV diagram obtaining part 100, a feature value extracting part 200 and a diagnosis analyzing part 300, and the diagnosis analyzing part 300 includes a database 310, a learning part 320 and a deciding part 330.

The failure diagnosis system 10 according to the present example embodiment is configured to diagnose the failure of the marine engine combustion chamber, and for example, may be configured to diagnose the failure of the engine operated in the marine engine combustion chamber. Further, in the present example embodiment, the failure of the engine is determined based on whether a cylinder is operated with a normal state or not. If there is a component that does not perform normal operation among the various components that make up the marine's engine, the cylinder combustion operation may be finally implemented in an abnormal state. Further, since the most important component in the operation of engine components is the cylinder, in the present example embodiment, malfunction or failure in the operation of the marine engine combustion chamber may be diagnosed, based on the diagnosis of the cylinder combustion operation state.

Thus, hereinafter, the failure diagnosis system 10 based on the cylinder combustion operation state is explained in detail.

First, the PV diagram obtaining part 100 obtains a PV (pressure-volume) diagram which is a relationship between a volume of the cylinder and a pressure of the cylinder, for each of the cylinders operated in the marine engine.

Generally, the marine engine includes a plurality of the cylinders, and the PV diagram obtaining part 100 should obtain the PV diagram which is the relationship between the volume of the cylinder and the pressure of the cylinder for each cylinder.

FIG. 2 shows an example PV diagram extracted by the PV diagram obtaining part 100.

Referring to FIG. 2, with an X-axis as a volume and a Y-axis as a pressure, the change relationship between the volume and the pressure is derived according to the operating characteristics of the cylinder.

In FIG. 2, TDC is a top dead center, which is the position when the piston is at its highest point. EVC is a state in which an exhaust valve is closed. BDC is a bottom dead center, which is the position when the piston is at its lowest point. IVC is a state in which an injection valve is closed. FI is a fuel injection point. EVO is a state in which the exhaust valve is open. IVO is a state in which the injection valve is open.

As shown in FIG. 2, the PV diagram may be obtained according to the driving state of each of the cylinders.

Accordingly, when the PV diagram obtaining part 100 obtains the PV diagram as in FIG. 2, the feature value extracting part 200 extracts predetermined (or defined) feature values from the PV diagram.

Here, the feature value extracting part 200 extracts the defined feature values as an average value over a predetermined time, for example, 1 second. Thus, the variable state of the combustion state of the marine engine combustion chamber may be determined more accurately.

The pre-defined feature values are the defined feature values for diagnosing the failure in the failure diagnosis system according to the present example embodiment, and are the 7 features through which the driving characteristics of the cylinder are determined from the PV diagram.

The pre-defined feature values may include at least one of a maximum value of pressure (Pmax), a compression or expansion stroke area (Pic), an intake and exhaust stroke area (Pis), a difference between maximum pressure and pressure during fuel injection (ΔP), an angle difference between maximum pressure and fuel injection (Δθj), a slope between maximum pressure and fuel injection (Slope), and a curvature from maximum pressure to bottom dead center (Cur).

More specifically, detailed contents of the feature values and the method for extracting the feature values from the PV diagram are explained as follows.

First, the maximum value of pressure (Pmax) is obtained by Equation (1) below.

$${P}_{m ax} = \frac{1}{N} {{\sum }_{i = 1}}^{N} {P}_{i} \qquad Equation ( 1 )$$

Here, N is the number of samples within ±1° based on a fuel injection angle when the pressure has a maximum value.

The maximum value of the pressure (Pmax) means the maximum pressure in the corresponding cycle and corresponds to the pressure value at the position indicating the maximum pressure in the PV diagram of FIG. 2. Here, in order to accurately derive the pressure value at the position representing the maximum pressure, the number of samples may be extracted as in Equation (1) above, and the pressure value may be derived based on the average value of the pressure for the extracted number of samples.

In addition, the compression or expansion stroke area (Pic) is obtained by Equation (2) below.

$${P}_{ic} = {\int }_{{TDC}_{c} - 180 °}^{{TDC}_{c} + 180 °} Pd ⊖ \qquad Equation ( 2 )$$

Here, TDC means the top dead center of the piston as explained above, and TDC which is the piston top dead center involved in performing the compression or expansion stroke, may be defined as TDCc (i.e., TDC2). In addition, P is a pressure, and θ is a crank angle.

Here, as illustrated in FIG. 2, the compression or expansion stroke area (Pic) is defined as an area occupied by the PV diagram between BDC1˜TDC2˜BDC2, and may be derived by Equation (2) above.

In addition, the intake and exhaust stroke area (Pis) is obtained by Equation (3) below,

$${P}_{is} = {\int }_{{TDC}_{s} - 180 °}^{{TDC}_{s} + 180 °} Pd ⊖ \qquad Equation ( 3 )$$

Here, TDC means the top dead center of the piston as explained above, and TDC which is the piston top dead center involved in performing the intake and exhaust stroke, may be defined as TDCs (i.e., TDC1). In addition, Pis a pressure, and θ is a crank angle.

Here, the intake and exhaust stroke area (Pis) means the intake and exhaust stroke area before/after the combustion. As illustrated in FIG. 2, the intake and exhaust stroke area (Pis) is defined as an area occupied by the PV diagram after TDC1˜BDC1 and BDC2, and may be derived by Equation (3) above.

In addition, the difference between the maximum pressure and the pressure during fuel injection, ΔP, as illustrated in FIG. 2, is defined as the difference between the maximum pressure (Pmax) derived above and the pressure at the fuel injection point (FI). The pressure difference ΔP may be easily derived from the PV diagram of FIG. 2.

In addition, the angle difference between maximum pressure and fuel injection, Δθj, as illustrated in FIG. 2, means an angular change within the PV diagram from the fuel injection point (FI) to the maximum pressure (Pmax). The angle difference Δθj may be easily derived from the PV diagram of FIG. 2.

In addition, a slope between maximum pressure and fuel injection (Slope) is obtained by Equation (4) below.

$$Slope = \frac{△ P}{△ ⊖ {B}_{j}} \qquad Equation ( 4 )$$

Here, as explained above, ΔP is defined as the difference between the maximum pressure (Pmax) derived above and the pressure at the fuel injection point (FI), and Δθj is defined as the angular change within the PV diagram from the fuel injection point (FI) to the maximum pressure (Pmax). Thus, the slope between maximum pressure and fuel injection (Slope) may be easily derived from the PV diagram of FIG. 2, too.

In addition, the curvature from the maximum pressure to the bottom dead center (BDC), Cur, as illustrated in FIG. 2, may be derived from the PV diagram of FIG. 2, by extracting a curvature between TDC2˜BDC2 in the PT diagram.

Accordingly, the feature value extracting part 200 extracts the 7 feature values defined above from the PV diagram, and the extracted feature values are provided to the diagnosis analyzing part 300.

The diagnosis analyzing part 300 diagnoses a normal state or an abnormal state of the corresponding cylinder combustion operation, based on the provided feature values. Here, the diagnosis of the diagnosis analyzing part 300 may be performed using learning results of the learning part 320.

For this, the learning part 320 previously performs a learning (machining learning or deep learning) using the feature values, on whether the cylinder combustion operation is at the normal state or not.

For example, data on the feature values pre-extracted according to the various states of the cylinder are stored in the database 310. Here, both the feature values extracted when the cylinder operates normally as well as the feature values extracted when the cylinder operates abnormally are stored in advance in the database 310.

Further, at the current stage or process, data on the feature values extracted from the cylinder that is the target of the failure diagnosis, and the results determined by the deciding part 330 are also stored in the database 310. Thus, the database 310 may be updated in real time.

Thus, the learning part 320 performs a predetermined learning based on contents stored in the database 310 in advance. Here, the learning part 320 performs the learning using the machine learning or the deep learning.

The learning part 320 performs the learning on the result values of the seven feature values extracted when the cylinder operates in the normal state, which are previously stored in the database 310. In addition, the learning part 320 performs the learning on the result values of the seven feature values extracted when the cylinder operates in the abnormal state, that is, when a malfunction or a failure of the cylinder occurs.

Thus, comparison learning may be performed on the extracted feature values when the cylinder operating in the marine engine is in the normal state and when the cylinder is in the abnormal state.

Based on the learning results from the learning part 320, the deciding part 330 decides whether the cylinder is in the normal state or in the abnormal state, based on the above seven feature values extracted for the cylinder in question, that is, the cylinder that needs to be judged whether the cylinder is in the normal state or the abnormal state. In addition, as explained above, the results determined in this way are stored in the database 310 along with the extracted feature values, and the stored contents are updated in real time.

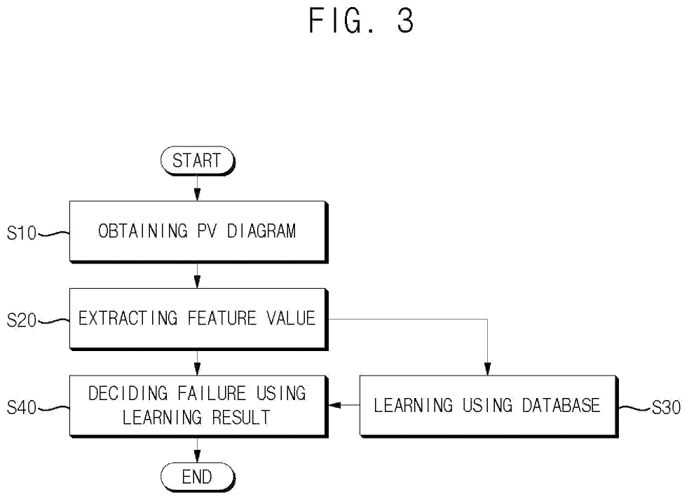

FIG. 3 is a flow chart illustrating a method for diagnosing failure of the marine engine combustion chamber using the failure diagnosis system of FIG. 1.

Referring to FIG. 3, in the method for diagnosing the failure of the marine engine combustion chamber using the failure diagnosis system 10, the PV diagram is obtained for each of cylinders operated in the marine engine in the PV diagram obtaining part 100 (step S10). Here, as explained above, the PV diagram shows the relationship between the volume of the cylinder and the pressure of the cylinder.

Then, the feature value extracting part 200 extracts the pre-defined feature values from the PV diagram (step S20). Here, the extracted feature values are explained above referring to FIG. 2.

In addition, as explained above, when the feature value extracting part 200 extracts the feature values, the feature value extracting part 200 extracts the defined feature values as an average value over a predetermined time, for example, 1 second.

The learning part 320 performs a pre-learning on the feature values extracted from the cylinder in the normal state and the feature values extracted from the cylinder in the abnormal state, based on the stored data of the database 310 in which the feature values on the combustion state of the cylinder (step S30).

Thus, the deciding part 330 decides whether the cylinder is in the normal state or abnormal sate of the cylinder in question, based on the feature values extracted from the cylinder in question to determine whether the cylinder is in the normal state or abnormal state, using the pre-learning results of the learning part 320 (step S40).

Hereinafter, the accuracy and reliability of the learning results of the learning part 320 and the results of determining whether there is the failure will be described by illustrating that some cylinders are in the failure state with respect to the cylinders operated in an actual marine engine.

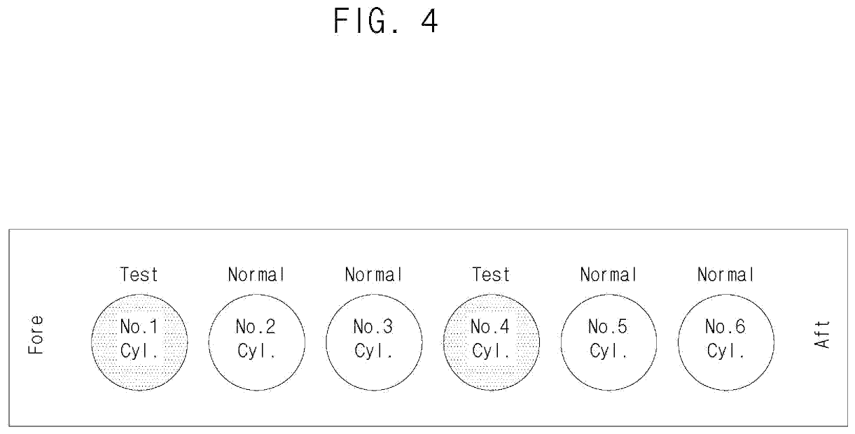

FIG. 4 is a schematic view illustrating a failure state of cylinders of the marine engine, in the failure diagnosis test using the failure diagnosis system of FIG. 1.

Referring to FIG. 4, for a total of six cylinders used in the marine engine, the first and fourth cylinders were assumed to be in the failure state, and the remaining cylinders were assumed to be in the normal state. Then, the results of failure state diagnosis of the cylinders using the learning results of the learning part were tested.

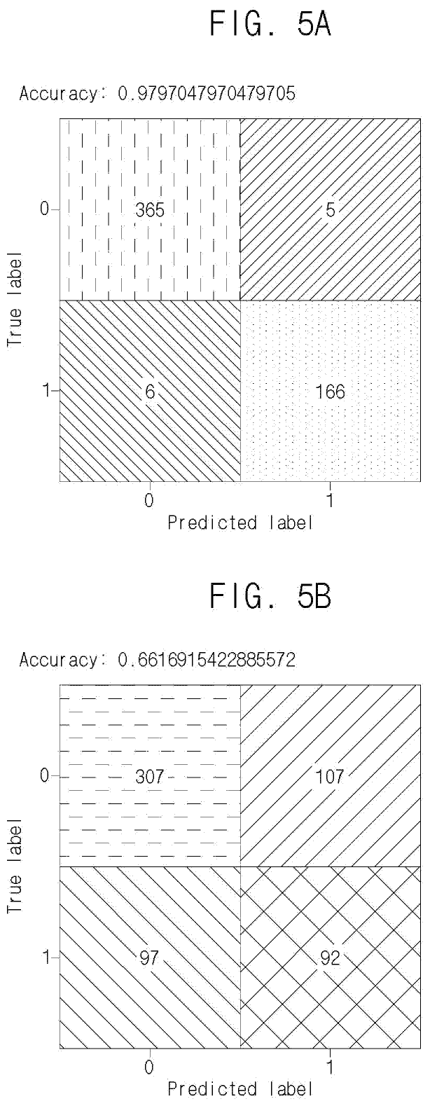

FIG. 5A and FIG. 5B are graphs showing an accuracy of the diagnosis results of the learning part, in the failure diagnosis test using the failure diagnosis system of FIG. 1.

FIG. 5A and FIG. 5B show a so-called confusion matrix that evaluates the accuracy of a specific model. FIG. 5A is the accuracy evaluation result of the learning model using the learning part 320 in the present example embodiment, and FIG. 5B is the accuracy evaluation result of the model when raw data is used as is.

The model using the raw data in FIG. 5B shows the accuracy of the learning results obtained by receiving all data regarding the cylinder combustion operation state, on the cylinder combustion operation of the normal cylinder combustion operation and the abnormal cylinder combustion operation. However, when receiving all of the above raw data, the amount of data is so large that the learning is impossible, so that the learning was performed on data that was scaled down to the average value once per second.

Accordingly, based on the results of this learning, the deciding result of the cylinder combustion operation was compared with the result of the actual cylinder combustion operation state, and the accuracy of the learning result of the scaled down raw data was shown.

FIG. 5A shows the accuracy of the learning result of the learning part 320 according to the present example embodiment, by comparing with the actual cylinder malfunction state. Here, the learning part 320 performs the learning based on the seven feature values extracted from the PV diagram of the normal state cylinder and the abnormal state cylinder stored in the database 310.

Then, referring to FIG. 5A and FIG. 5B, it may be seen that the accuracy of the results learned through the learning part 320 according to the present example embodiment of FIG. 5A is very high at 98%. Therefore, it may be confirmed that it is possible to effectively and accurately determine whether the cylinder combustion operation is in the normal state even through the learning using only the seven feature values extracted from the PV diagram.

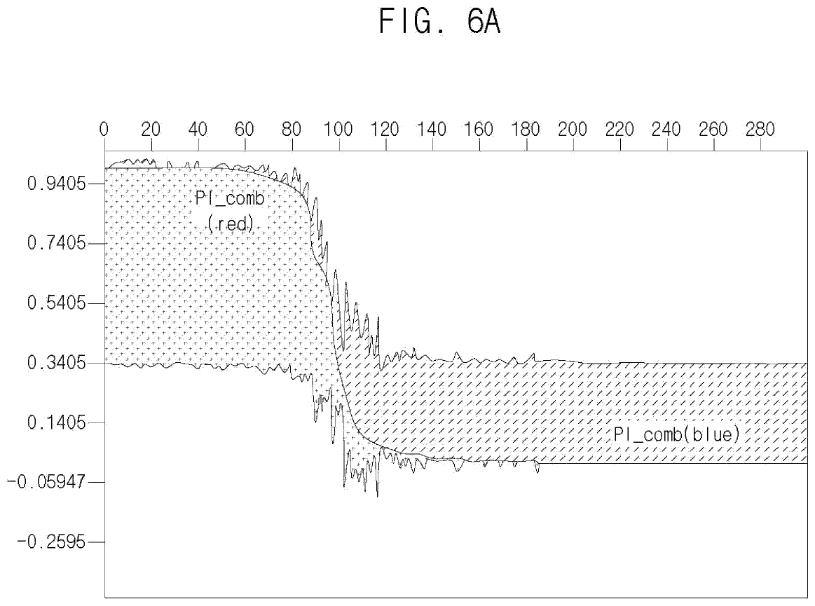

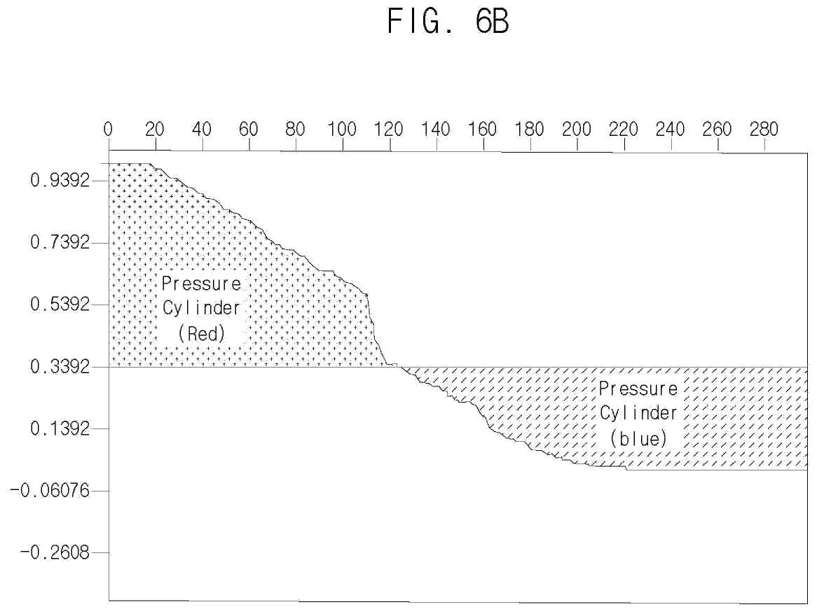

FIG. 6A and FIG. 6B are graphs showing reliability of the learning results of the learning part, the failure diagnosis test using the failure diagnosis system of FIG. 1. FIG. 6A and FIG. 6B are graphs for evaluating the reliability of each learning model with respect to the learning results of FIG. 5A and FIG. 5B.

In FIG. 6A and FIG. 6B, for example, cases determined to be the cylinders in the normal state are displayed in the (+) area (red, upper side of the graph), and cases determined to be the cylinders in the abnormal state are displayed in the (−) area (blue, lower side of the graph).

Thus, referring to FIG. 6A and FIG. 6B, it may be seen that the results of the learning using the learning part 320 according to the present example embodiment in FIG. 6A are more clearly derived in the cases determined to be in the normal state and the cases determined to be in the abnormal state. In other words, it is confirmed that the values on the graph in the (+) area and the values on the graph in the (−) area are drawn to be clearly distinguished. As shown in FIG. 6B, it may be seen that the area where the distinction becomes ambiguous is minimal as the value gradually decreases (as illustrated in a diagonal shape).

However, although an overlapping data was obtained in the border area in FIG. 6A, this is merely the result of many cases used for the learning, and it may be clearly seen that the area where the value gradually decreases at the border line is narrower than that in FIG. 6B.

Accordingly, it may be confirmed that the reliability of the learning results is higher in the results of the learning using the learning part 320 according to the present example embodiment, as shown in FIG. 6A.

According to the present example embodiments, feature values are extracted from the PV diagram for the cylinder combustion operation and a state of the cylinder combustion operation is diagnosed by performing the learning based on the feature values, so that the combustion conditions in the marine engine combustion chamber may be diagnosed more fast and accurate.

Here, unlike the conventional diagnosis of the cylinder combustion operation state, total 7 feature values are defined and the feature values are extracted from the PV diagram to diagnose the cylinder combustion operation state, so that the accuracy of diagnosis of the cylinder combustion operation state may be enhanced, by considering redundant consideration of various feature values.

In addition, in diagnosing the cylinder combustion operation state based on the feature values, the learning results through the learning part are utilized. Thus, unnecessary calculations on multiple feature values are minimized, and the operation state may be diagnosed by analyzing the correlation between the feature values using an artificial intelligence. Then, calculation time and judgment time may be minimized, and the accuracy of the diagnosis may also be improved.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A failure diagnosis system comprising:
a PV diagram obtaining part configured to obtain a PV diagram for each of cylinders operated in a marine engine, the PV diagram showing a relationship between a volume of the cylinder and a pressure of the cylinder;
a feature value extracting part configured to extract pre-defined feature values from the PV diagram; and
a diagnosis analyzing part configured to diagnose a normal state or an abnormal state of a cylinder combustion operation from the feature values extracted from the cylinder, using a pre-learning result which is learned for the normal state or the abnormal state of the cylinder combustion operation using the pre-defined feature values.

2. The system of claim 1, wherein the diagnosis analyzing part comprises:
a database configured to store the pre-defined feature values extracted from each of the cylinders with the normal state and the abnormal state;
a learning part configured to learn the feature values of the cylinder with the normal state and the feature values of the cylinder with the abnormal state, which are stored in the database; and
a deciding part configured to decide whether the cylinder combustion operation is in the normal state or in the abnormal state, from the feature values extracted from the cylinder, using learned results of the learning part.

3. The system of claim 1, wherein the PV diagram is a graph showing a change of a pressure inside of the cylinder according to a change of a position of a piston inside of the cylinder.

4. The system of claim 1, wherein the pre-defined feature values comprises:
at least one of a maximum value of pressure (Pmax), a compression or expansion stroke area (Pic), an intake and exhaust stroke area (Pis), a difference between maximum pressure and pressure during fuel injection (ΔP), an angle difference between maximum pressure and fuel injection (Δθj), a slope between maximum pressure and fuel injection (Slope), and a curvature from maximum pressure to bottom dead center (Cur).

5. The system of claim 4, wherein the maximum value of pressure (Pmax) is obtained by Equation (1) below,
$${P}_{ma x} = \frac{1}{N} {{\sum }_{i = 1}}^{N} {P}_{i} \qquad Equation ( 1 )$$
wherein N is the number of samples within ±1° based on a fuel injection angle when the pressure has a maximum value.

6. The system of claim 4, wherein the compression or expansion stroke area (Pic) is obtained by Equation (2) below,
$${P}_{ic} = {\int }_{{TDC}_{c} - 180 °}^{{TDC}_{c} + 180 °} Pd ⊖ \qquad Equation ( 2 )$$
wherein TDCc is a top dead center of a piston, P is a pressure, and θ is a crank angle.

7. The system of claim 4, wherein the intake and exhaust stroke area (Pis) is obtained by Equation (3) below,
$${P}_{is} = {\int }_{{TDC}_{s} - 180 °}^{{TDC}_{s} + 180 °} Pd ⊖ \qquad Equation ( 3 )$$
wherein TDCs is a top dead center of a piston, P is a pressure, and θ is a crank angle.

8. The system of claim 4, wherein slope between maximum pressure and fuel injection (Slope) is obtained by Equation (4) below,
$$Slope = \frac{△ P}{△ {⊖}_{j}} \qquad Equation ( 4 )$$
wherein ΔP is the difference between maximum pressure and pressure during fuel injection, and Δθj is the angle difference between maximum pressure and fuel injection.

9. The system of claim 4, wherein the feature value extracting part is configured to extract the features values as an average value during a predetermined time.

10. A method for diagnosing failure comprises:
obtaining a PV diagram for each of cylinders operated in a marine engine, the PV diagram showing a relationship between a volume of the cylinder and a pressure of the cylinder;
extracting pre-defined feature values from the PV diagram;
learning the feature values of the cylinder with a normal state and the feature values of the cylinder with an abnormal state, which are stored in a database; and
diagnosing the normal state or the abnormal state of the cylinder, using learning results in the learning the feature values of the cylinder.

11. The method of claim 10, wherein the pre-defined feature values comprises:
at least one of a maximum value of pressure (Pmax), a compression or expansion stroke area (Pic), an intake and exhaust stroke area (Pis), a difference between maximum pressure and pressure during fuel injection (ΔP), an angle difference between maximum pressure and fuel injection (Δθj), a slope between maximum pressure and fuel injection (Slope), and a curvature from maximum to bottom dead center (Cur).
